(19) United States
(12) Patent Application Publication
(10) Pub. No.: US 2023/0055736 A1
(43) Pub. Date: Feb. 23, 2023

(54) SYSTEM AND METHOD FOR A DISTRIBUTED LEDGER TRACKING ANIMALS

(71) Applicant: Pondata LLC, Cheyenne, WY (US)

(72) Inventor: Justin Oberg, Vancouver, WA (US)

(73) Assignee: Pondata LLC, Cheyenne, WY (US)

(21) Appl. No.: 17/820,492

(22) Filed: Aug. 17, 2022

Related U.S. Application Data
(60) Provisional application No. 63/234,011, filed on Aug. 17, 2021.
(60) Provisional application No. 63/249,436, filed on Sep. 28, 2021.

(51) Int. Cl. G06F 16/23; G06K 7/10; H04L 9/32

(52) U.S. Cl. CPC G06F 16/23; G06K 7/10366; H04L 9/3247

(57) ABSTRACT

Disclosed are a system and method for using a distributed ledger for the tracking of animals. The system and method make use of blockchain and NFTs to track living animals throughout their lives. These animals can include livestock, including cattle, pigs, chicken, horses, oxen, mules, etc., as well as for, e.g., verified tracking of wildlife such as deer, elk, bear, moose, birds, antelope. Animals may be tagged with a Bluetooth or other tracking device, and their information may be stored on a distributed ledger. An NFT for the animals may be used as proof of ownership.

### CROSS-REFERENCE TO RELATED APPLICATIONS

This patent application claims the benefit of U.S. Provisional Patent Application Nos. 63/234,011, filed on Aug. 17, 2021, and 63/249,436, filed on Sep. 28, 2021, which are hereby incorporated by reference in their entirety.

### TECHNICAL FIELD

The present disclosure relates to a distributed ledger system for tracking animals, and more specifically to using NFTs (Non-Fungible Token) as a proof of ownership which allows owners to update the record of a particular animal.

### BACKGROUND

People are increasingly concerned about where and how their meat is raised, what vaccines and other veterinarian medicines were provided to the animals, if the animals were grass fed or corn fed, etc. However, tracking that information for each individual animal can be difficult. In addition, the possibility exists that entities within the supply chain may modify, falsify, or otherwise change the animal's record to enhance the perceived value of the resulting animal products. Similar problems exist with other domesticated animals, such as cats, dogs, and/or other pets, where the identity of the animal, how it has been cared for, and its ownership can be important to prospective buyers.

Supply chain systems using distributed ledgers (i.e., blockchain) have been developed to track products as they move from entity to entity, and eventually the retailer and consumer. However, such systems do not allow for additional information to be appended to an animal over its lifetime.

### SUMMARY

A distributed ledger-based animal tracking system platform is introduced to make use of blockchain and NFTs to track living animals throughout their lives. These animals can include livestock, including (but not limited to) cattle, pigs, chicken, horses, oxen, mules, etc. The animals can also include pets, such as dogs and cats. This solution can also be used for verified tracking of wildlife such as deer, elk, bear, moose, birds, antelope. Animals are tagged with unique identifiers which is used to create a unique digital identity for the animal (e.g., biometric images+unique Bluetooth identification+user input). The digitial identity can be sent via a DApp (Decentralized App) to the Ethereum blockchain as part of a smart contract, resulting in an ERC-721 non-fungible token (NFT) for each individual animal. By settling the data on a distributed ledger system, an immutable record of the animal (including date/time/GPS/health records) is created. The NFTs can be placed within digital wallets of owners, managers, produces, or others associated with the animal. Ownership can thus be transferred or fractionalized using the NFTs.

### BRIEF DESCRIPTION OF THE DRAWINGS

FIG. 1 illustrates an example method embodiment;

FIG. 2 illustrates an example computer system;

FIG. 3 illustrates an example verification process;

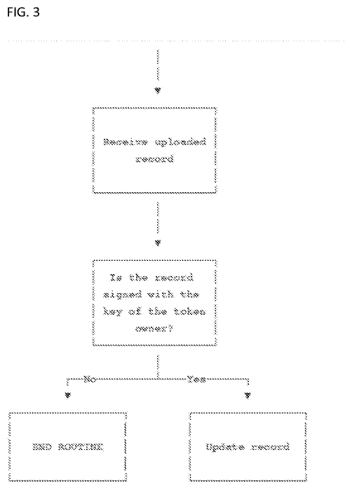

FIG. 4 illustrates an example temporal diagram of adding appended records to a blockchain;

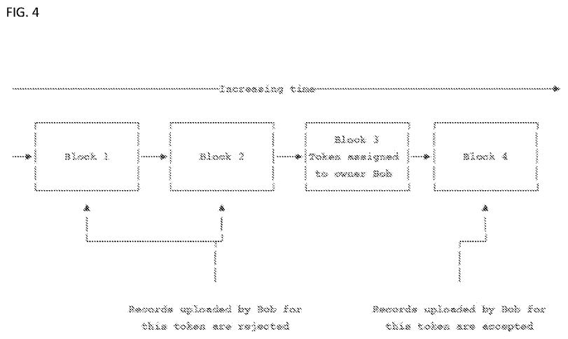

FIG. 5 illustrates an example of adding additional data to a token;

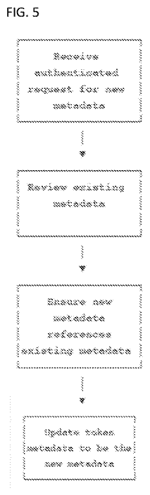

FIG. 6 illustrates an example data model diagram; and

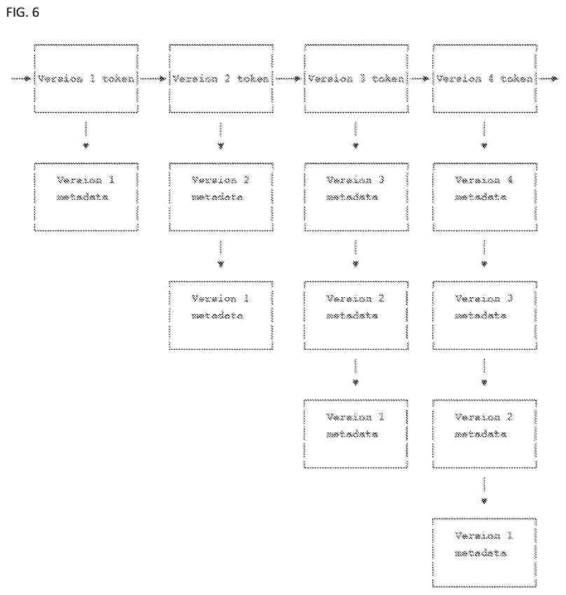

FIG. 7 illustrates an exemplary screen used for enrolling an animal and generating an NFT, in accordance with an embodiment of the disclosure.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

A distributed ledger is a consensus of replicated, shared, and synchronized digital data geographically spread across multiple sites, countries, or institutions. Unlike with a centralized database, there is no central administrator. One particular type of distributed ledger is a blockchain. A blockchain is a shared, immutable ledger that facilitates the process of recording transactions and tracking assets in a business network. An asset can be tangible (a house, car, cash, land) or intangible (intellectual property, patents, copyrights, branding). Virtually anything of value can be tracked and traded on a blockchain network, reducing risk and thereby cutting costs for all involved.

“DApps” (also known as decentralized apps) are typically decentralized, incentivized through providing tokens to those who validate the DApp, and in compliance with a specific protocol agreed upon within the community. DApps may run on top of distributed ledgers/computing systems such as Ethereum. For example, the decentralized applications are stored on and executed by a blockchain system and/or distributed ledger system.

Non-Fungible Tokens (“NFTs”) (such as and including the ERC-721 Protocol, though other forms of NFT are equally applicable), can represent ownership over digital or physical assets. For example, NFTs can include: Physical property (e.g., houses, unique artwork); Virtual collectables (e.g., unique pictures of kittens, collectable cards); and “Negative value” assets (e.g., loans, burdens and other responsibilities).

In general, all houses are distinct and no two kittens are alike. NFTs are distinguishable and the ownership of each one must be tracked separately.

The solutions disclosed herein make use of blockchain and NFTs to track living animals throughout their lives. These animals can include livestock, including (but not limited to) cattle, pigs, chicken, horses, oxen, mules, etc. The animals can also include pets, such as dogs and cats. This solution can also be used for verified tracking of wildlife such as deer, elk, bear, moose, birds, antelope.

An example system can follow the following steps:

The first step is to “tag” each animal with a unique identifier, meaning to implant, append, or affix a portable/mobile device on the animal which can identify a specific animal. Examples can include ear tags, or tags placed under the skin of the animal. In some cases, this tag can broadcast a signal using RFID (Radio Frequency Identification), Bluetooth, NFC (Near Field Communication), UHF (Ultra High Frequency), and/or any other type of wireless Radio Frequency communication, where the broadcast signal provides a unique identifier of the tagged animal (meaning no two animals would have the same identifier). In other cases, the tag can have a bar code (such as a QR code), or a written/printed number/identification (which can be recognized by image recognition systems) which, when scanned by a user, provides the unique identifier. As an example, a rancher, biologist, or other user can implant a sensor on the animal which provides regular “proof of life” data updates via Bluetooth such as heart rate, temperature, movement, location, and other health data. In some cases, these updates can be wirelessly transmitted from the implanted device to a server, which can collect the data in a lifetime record for the animal. In other cases, the updates can be wirelessly transmitted from the implanted device to a mobile device, such as a smartphone, tablet, or other portable computing device, which can then relay the information to the server. In yet other cases, the health/location/other data for the animal can be manually entered into a record on the mobile device by the user who has scanned and identified the animal, at which point it can be relayed to the server. For example, manual data input from the user can be entered via an app on a smartphone, providing the ability to add information about the animal such as sex, non-hormone treated, source/age verification, antibiotic-free, grass or grain fed, all-natural, organic, and/or vaccinations.

The system can also utilize biometric recognition (such as facial photos and videos), processed through artificial intelligence for each animal. For example, when tagging the animal a photograph or video of the animal can be taken and processed. Later, when additional photos or video of the animal is captured, the animal can be identified. The additional photos, video, and or location of the animal can then be added to the overall record of the animal.

In some configurations, such as a ranch where the owner of the animals wants to be in (relatively) constant communication with the tags, the rancher's smartphone, field processor, or another remote sensor can be configured to receive signals from each tag (for example, establishing a Bluetooth connection between each tag and the rancher's smartphone, or establishing an RFID connection between the tags and an RFID receiver/sensor which in turn relays the data to a server) to capture a unique identifier associated with each implant.

The unique digital identity data for each animal (biometric images+unique Bluetooth identification+rancher input) can be sent via a DApp (Decentralized App) to the Ethereum blockchain as part of a smart contract, resulting in an ERC-721 non-fungible token (NFT) for each individual animal. By settling the data on a distributed ledger system, an immutable record of the animal (including date/time/GPS/health records) is created.

The smart contract which creates the NFTs can also place the NFTs within wallets of an owner, manager, producer, or other individual with responsibility for the animal associated with the NFT. For example, the system can place the NFT for a tagged cow into the electronic wallet of the rancher who owns the tagged cow. Once each token is sent to the secure digital wallet of the owner of the animal (or supervisor in the case of wildlife), metadata such as feed, health treatments, veterinary and brand inspections, genetic information, photos and video of the animal, GPS locations and other relevant information can be added to each token. That is, the NFT is not fixed in size or content, and additional information can be appended to the NFT over time. For example, as the animal moves locations, the updated locations can be added to the NFT record. Likewise, as the animal undergoes various treatments, those treatments can be added to the animal's NFT record.

In some configurations, the system can allow for fractional ownership of each animal, creating the ability to sell a portion of the animal (e.g., a quarter beef or any other fraction) direct to buyers or investors. In other words, multiple parties may own a single animal, with each owning entity having the ability to sell or exchange their portion. In such configurations, the ownership of the animal can be separated from the ability to append data to the NFT. For example, while all owners may have the ability to sell/exchange their tokens, a single owner or responsible entity may be tasked with the ability to append data about the associated animal. Any metadata that entity adds would then be propagated to the other tokens associated with the animal. In other configurations, all of the users having tokens associated with an animal can append data to the NFTs.

When the owner or manager of the animal sells or transfers ownership of the animal, the system allows transfer of the animal's NFT from the digital wallet of the first owner to the digital wallet of the second owner. As the user interacts with the system via a smartphone app, they can transfer the NFT (including any appended metadata) from the digital wallet of the owner/custodian to the digital wallet of the new owner/custodian. If, for example, this is being done on the Ethereum blockchain, transfer of the NFT from one owner to another can require a certain amount of “gas,” to perform the transaction. This process of appending metadata about the animal and/or transferring ownership of the animal can continue throughout the animal's lifetime.

As the ultimate repository for all data sources associated with the history of an animal, the system provides traceability for all interested parties. The system's blockchain technology, built on Ethereum smart contracts (though any smart contract blockchain/immutable ledger can also work), allows verification of the unique data sources and can create proof of ownership. Each individual animal can be represented as an ERC-721 token, or Non-Fungible Token (NFT) and securely stored in the owner's private digital wallet while collecting and adding metadata (health, feed, movement, heartbeat, facial analysis, etc.) to the NFT. The token owners can share data with permissioned viewers such as inspectors, buyers, vets or animal processors. Every animal's data record will remain with it through harvest, and a unique QR code can be printed on the packaging of resulting animal products. Consumers will be able to scan the QR code with any smart device to get select details on that specific animal including proof of identity.

By providing industry producers with this solution, the project participants provide private, secure, immutable proof of ownership and traceability for animals seamlessly across the supply chain from ranch-to-consumer, or throughout the lifetime of a pet, wildlife animal, etc.

Consider the following series of example steps for an exemplary rancher interacting with cattle. 1) Rancher registers at on a system website (name, ranch, location, etc. . . . ). 2) The rancher sets up a digital wallet. 3) The rancher has herd ready for tagging. 4) Individual cows are pulled aside and tagged with a visual, RFID, UHF or Bluetooth tag. 5) The rancher opens an app on their phone and uses a smartphone or tag scanner to read the tag unique identifier of each animal, as well as collect GPS (Global Positioning System)/date/time data. 6) The rancher can take a photograph and/or video of a cow. 7) The rancher can use an app which allows the rancher to enter custom information (breed, sex, vaccines, color, grassfed, etc. . . . ) about the individual cow. 8) Information about the animal is sent from the rancher's phone (ultimately) to a distributed ledger. 9) Information is verified by a decentralized network and “hashed” onto the distributed ledger, thus creating digital token of each animal that will reside in rancher's digital wallet as proof of ownership. 10) The rancher can add metadata/information to each individual animal manually or through upload (brand inspection certificate, certificate of veterinary inspection, PVP certification, health treatments). 11) The rancher can give permission to third parties to view token information (regulators, vets, buyers, feedlots). 12) A buyer of the animal registers with the system and sets up digital wallet. 13) The rancher makes a deal with the buyer to buy cattle based on attributes of each animal which are verified by the blockchain record. 14) The rancher delivers the cattle to buyer and buyer inspects cattle. Both agree terms of sale have been met. Each party verifies agreement through the system/an app associated with the system. 15) The token created by the smart contract is transferred to the digital wallet of the buyer of cattle. 16) Payment from the buyer is transferred in real time to rancher. The buyer can pay in US dollars or cryptocurrency via the system/app. 17) The cattle go to a feed lot or pasture and more data is added by the new owner. 18) The cattle go to an animal processor and more data added. 19) The cattle are cut into fractions and go to consumer. 20) Consumer scans QR code associated with each respective animal and gets the history of the animal.

Some exemplary benefits of this system include:
Using a smart contract protocol to capture, verify and display valuable data on animals, while reducing inefficiencies in the process.
Creating a 100% verifiable digital record of source, age and country of origin on each animal.
Creating a chronological timeline of the animal using all the data collected throughout the lifecycle of the animal, which can include a daily “snapshot” of the animal (such as health data, pictures/video and geolocation of the animal).

Creating a direct link of verified information between the producer and the consumer.

Creating a stream of verified and trusted data in a trustless ecosystem from multiple IoT collection devices in combination with manually created inputs.

The tokens allow for the animals to be collateralized, so the owner can get credit instantly at point of sale and satisfying liens. These tokens can also act as collateral for lenders, where the tokens can be held by a lender or in escrow as part of a loan or contract.

Provides Complete data security for the animal owner because of encryption and immutable nature of the system.

Provides for secure individual tracking of animals and all associated metadata.

Creates rules for fractional ownership of each animal, creating the ability to sell any fraction of the animal directly to buyers or investors.

Provides a platform for third-party certifiers to digitally verify and audit process claims (e.g., grass-fed, organic, all-natural, NHTC, etc.)

The token owners can share data with permissioned viewers such as inspectors, buyers, veterinarians, or processors.

Every animal's data record will remain with it through harvest, and a unique QR code will be printed on the packaging.

Consumer's will be able to scan the QR code with any smart device to get select details on that specific animal including proof of identity (source and age verified).

Regarding how verification of uploaded records is implemented, preconditions to verifying a cryptographic signature from a purported owner can include: (1) The uploaded record comes from another system; (2) The uploaded record includes specification of an individual livestock, such as by referencing an ERC-721 token identifier; (3) The uploaded record includes a cryptographic signature, such as an elliptic curve cryptography; (4) Ownership records for individual livestock are identified, such as by referencing an ERC-721 token identifier; and/or (5) Ownership records for individual livestock are associated with an owner's cryptographic signature, such as an elliptic curve cryptography asymmetric public key.

Verification that the cryptographic signature of the uploaded recorded corresponds to the owner's cryptographic signature for the animal can occur by: (1) Recovering the cryptographic asymmetric public key from the uploaded record cryptographic signature, such as by using the elliptic curve digital signature algorithm (ECDSA) public key recovery function; (2) Comparing the recovered public key from the uploaded record to the corresponding livestock owner's public key; and (3) If these are matching, the verification is successful; otherwise the verification is a failure.

After verification is successful, the system can transmit the uploaded record to the distributed ledger. This can include: (1) Storing the uploaded records; (2) Noting those records are authorized; and/or (3) Storing these authorized records in such a way that authorized records for a given token may be retrieved, such as by storing them as metadata on the livestock ERC-721 token.

The verification step can allow the curation of documents which are authorized by the owner of the livestock. One potential use case is that the owner of livestock may encumber their ownership record with a financial lien. Such a lien can be verified as being authorized and submitted by the actual owner of the livestock. Banks and other financial intermediaries can depend on this lien being binding on the actual livestock owner since the livestock owner authorized it. Another hypothetical system which does not include the verification step would be much less useful in this use case because any liens recorded in that system may have been a result of an upload by the system administrator or some other party and which is not authorized by the livestock owner.

Appending additional information to an existing token, such as a token associated with a specific animal, requires that an updated record has been provided for a given token and that the record is authenticated as having been sent by the owner of the livestock. The appending process can then include: (1) The existing reference of file(s) attached to the token (if any) are retrieved from the blockchain, such as by using a SHA-256 hash of the file(s) as attached to the token's ERC-721 metadata; (2) The new file(s) are inspected to ensure that reference is made to the existing reference of file(s) (if any), such as by inspecting a designated location in a JSON payload; (3) If the new file(s) does not include a reference to the existing file(s) (if any) the update is rejected, such as by revert the blockchain transaction; (4) The new file(s) are set as the token's reference, such as by setting the ERC-721 metadata to the file(s) SHA-256 hash; and (5) The new file(s) are persisted to disk, such as by saving the files in the content-addressable file storage system IPFS.

Because the blockchain is based on multiple, disinterested, distributed parties that have strong economic incentives to ensure all blockchain rules are followed, inspecting the current state of the blockchain provides prima facie evidence that all records were produced within the specifications of the constituent smart contracts. In the instance of the present invention, the smart contract ensures that all records attached to a token (i.e., associated with a livestock) were added under the authority of that token's then-owner. And furthermore, because every version of the every uploaded documents is referenced in the current version of the token or is referenced (recursively) in subsequent document versions that are referenced in the current version of the token, this ensures that every token provides a full and auditable history of all documents attached to the token. The end result is that all for all livestock are preserved in a tamper-proof and permissioned system that allows only the owner of livestock to augment records.

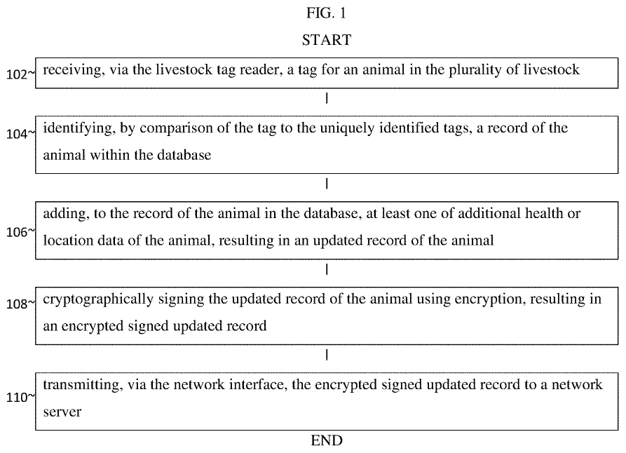

FIG. 1 illustrates an example method embodiment. As illustrated, the system performing the illustrated method, such as a handheld mobile device (smartphone, tablet, or other mobile computing device) can receive, via the livestock tag reader (such as a Bluetooth receiver, camera, etc.), a tag for an animal in the plurality of livestock (102). The system can then identify, by comparison of the tag to the uniquely identified tags, a record of the animal within the database (104). As the owner of an animal cares for the animal, tracks it, etc., the owner can use the system to add, to the record of the animal in the database, at least one of additional health or location data of the animal, resulting in an updated record of the animal (106). The system can then cryptographically sign the updated record of the animal using encryption, resulting in an encrypted signed updated record (108), and transmit, via a network interface, the encrypted signed updated record to a network server (110).

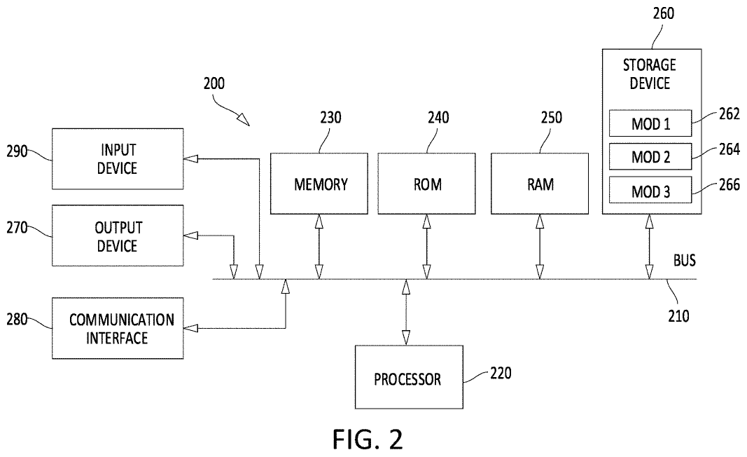

With reference to FIG. 2, an exemplary system includes a general-purpose computing device 200, including a processing unit (CPU or processor) 220 and a system bus 210 that couples various system components including the system memory 230 such as read-only memory (ROM) 240 and random access memory (RAM) 250 to the processor 220. The system 200 can include a cache of high-speed memory connected directly with, in close proximity to, or integrated as part of the processor 220. The system 200 copies data from the memory 230 and/or the storage device 260 to the cache for quick access by the processor 220. In this way, the cache provides a performance boost that avoids processor 220 delays while waiting for data. These and other modules can control or be configured to control the processor 220 to perform various actions. Other system memory 230 may be available for use as well. The memory 230 can include multiple different types of memory with different performance characteristics. It can be appreciated that the disclosure may operate on a computing device 200 with more than one processor 220 or on a group or cluster of computing devices networked together to provide greater processing capability. The processor 220 can include any general purpose processor and a hardware module or software module, such as module 1 262, module 2 264, and module 3 266 stored in storage device 260, configured to control the processor 220 as well as a special-purpose processor where software instructions are incorporated into the actual processor design. The processor 220 may essentially be a completely self-contained computing system, containing multiple cores or processors, a bus, memory controller, cache, etc. A multi-core processor may be symmetric or asymmetric.

The system bus 210 may be any of several types of bus structures including a memory bus or memory controller, a peripheral bus, and a local bus using any of a variety of bus architectures. A basic input/output (BIOS) stored in ROM 240 or the like, may provide the basic routine that helps to transfer information between elements within the computing device 200, such as during start-up. The computing device 200 further includes storage devices 260 such as a hard disk drive, a magnetic disk drive, an optical disk drive, tape drive or the like. The storage device 260 can include software modules 262, 264, 266 for controlling the processor 220. Other hardware or software modules are contemplated. The storage device 260 is connected to the system bus 210 by a drive interface. The drives and the associated computer-readable storage media provide nonvolatile storage of computer-readable instructions, data structures, program modules and other data for the computing device 200. In one aspect, a hardware module that performs a particular function includes the software component stored in a tangible computer-readable storage medium in connection with the necessary hardware components, such as the processor 220, bus 210, display 270, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 200 is a small, handheld computing device, a desktop computer, or a computer server.

Although the exemplary embodiment described herein employs the hard disk 260, other types of computer-readable media which can store data that are accessible by a computer, such as magnetic cassettes, flash memory cards, digital versatile disks, cartridges, random access memories (RAMs) 250, and read-only memory (ROM) 240, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 200, an input device 290 represents any number of input mechanisms, such as a microphone for speech, a touch-sensitive screen for gesture or graphical input, keyboard, mouse, motion input, speech and so forth. An output device 270 can also be one or more of a number of output mechanisms known to those of skill in the art. In some instances, multimodal systems enable a user to provide multiple types of input to communicate with the computing device 200. The communications interface 280 generally governs and manages the user input and system output. There is no restriction on operating on any particular hardware arrangement and therefore the basic features here may easily be substituted for improved hardware or firmware arrangements as they are developed.

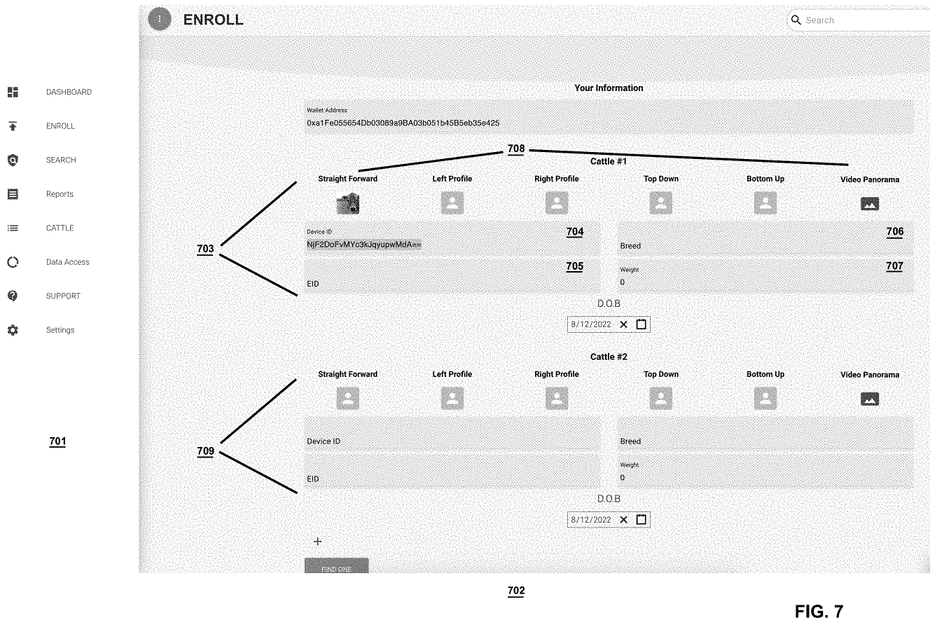

Turning to FIG. 7, an exemplary input/output screen is described for use in enrolling an animal into the database. A first portion of the screen 701 contains menu items with which a user can navigate among different aspects of the system, including an overall dashboard screen, an enrollment screen, a search screen, and a reports screen. Other screens and functions are also available from the menu portion. A second portion of the screen 702 includes information and fields with which a user can enroll an animal into the database. A user may enter an animal's device ID, such as a Bluetooth device ID, into a device ID field 704. A user may enter an EID, such as a USDA electronic identification number, for the animal into an EID field 705. A breed field 706 permits entry related to the animal's particular breed. A weight field 707 is used for entering the animal's weight. The enrollment screen also preferably contains buttons 708 or methods by which a user may enter images or video of the animal. Different angle images may be entered and stored and processed for, e.g., image recognition to confirm the animal's identity.

Use of language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

1-16. (canceled)

17. A user interface system for use with enrolling an animal in a distributed ledger-based livestock database comprising:
a processor;
a non-transitory computer-readable storage medium having instructions stored which, when executed by the processor, cause the processor to perform operations comprising:
displaying on an input screen an enrollment region including a set of fields for entry of information relating to the animal, including:
a device ID field; and
one or more image uploading selection fields for uploading images of the animal; and
transmitting the inputted information and images to enroll the animal as a record in the database.

18. The user interface system of claim 17 further comprising a livestock tag reader, wherein the device ID field is caused by the processor to be populated with information read by the livestock tag reader from a tag on the animal.

19. The user interface system of claim 18 further comprising a livestock tag reader, wherein the tags are Bluetooth tags, the livestock tag reader being configured to receive Bluetooth tags.

20. The user interface system of claim 17, the transmitted images containing sufficient data for image processing to recognize the animal through subsequently uploaded images.

21. The user interface system of claim 17, the displayed set of field further comprising a breed field.

22. The user interface system of claim 17, the image uploading selections comprising a video uploading option.

23. The user interface system of claim 17, the operations further comprising displaying on the input screen a menu region including a search option and a reporting option.

24. The user interface system of claim 17, the operations further comprising cryptographically signing the record of the animal for transmission to the distributed ledger.

25. The user interface system of claim 17, the operations further comprising displaying on the input screen a second set of fields for entry of information relating to a second animal.

26. A method for enrolling an animal in a distributed ledger-based livestock database comprising:
displaying on an input screen an enrollment region including a set of fields for entry of information relating to the animal, including:
a device ID field; and
one or more image uploading selection fields for uploading images of the animal; and
transmitting the inputted information and images to enroll the animal as a record in the database.

27. The method claim 26, further comprising:
reading a tag on the animal with a livestock tag reader; and
populating the device ID field with information from the livestock tag.

28. The method of claim 27 further comprising a livestock tag reader, wherein the tags are Bluetooth tags, the livestock tag reader being configured to receive Bluetooth tags.

29. The method of claim 26, the transmitted images containing sufficient data for image processing to recognize the animal through subsequently uploaded images.

30. The method of claim 26, the displayed set of field further comprising a breed field.

31. The method of claim 26, the image uploading selections comprising a video uploading option.

32. The method of claim 26, further comprising displaying on the input screen a menu region including a search option and a reporting option.

33. The method of claim 26, further comprising cryptographically signing the record of the animal for transmission to the distributed ledger.

34. The method of claim 26, further comprising displaying on the input screen a second set of fields for entry of information relating to a second animal.
